(19) United States
(12) Patent Application Publication
(10) Pub. No.: US 2024/0376329 A1
(43) Pub. Date: Nov. 14, 2024

(54) Ink Jet Ink Composition, Ink Jet Recording Method, And Ink Jet Recording Apparatus

(71) Applicant: SEIKO EPSON CORPORATION, Tokyo (JP)

(72) Inventor: Yuta ASAKAWA, Azumino (JP)

(21) Appl. No.: 18/660,284

(22) Filed: May 10, 2024

(30) Foreign Application Priority Data
May 11, 2023 (JP) 2023-078477

(51) Int. Cl. C09D 11/328; C09D 11/38

(52) U.S. Cl. CPC C09D 11/328; C09D 11/38

(57) ABSTRACT

An ink jet ink composition contains a sublimation dye; a sugar alcohol having at least four OH groups; a diol having two or three carbon atoms; at least one permeable moisturizer selected from the group consisting of a glycol monoether, a diol having at least four carbon atoms, an amide, and a (poly)glyceryl ether; and glycerin at a content of one percent by mass or less with respect to a total mass of the ink jet ink composition.

The present application is based on, and claims priority from JP Application Serial Number 2023-078477, filed May 11, 2023, the disclosure of which is hereby incorporated by reference herein in its entirety.

### BACKGROUND

### 1. Technical Field

The present disclosure relates to an ink jet ink composition, an ink jet recording method, and an ink jet recording apparatus.

### 2. Related Art

An ink jet recording method is a recording method in which small ink droplets are ejected from fine nozzles so as to be adhered to a recording medium. This method has advantages in that an image having a high resolution and a high quality can be recorded at a high speed using a relatively inexpensive apparatus. In addition, by the use of the ink jet recording method, dyeing (textile printing) is also performed on cloths and the like.

As the recording method, for example, a transfer recording method using a sublimation dye may be mentioned. In the recording method as described above, an ink jet ink composition is not directly adhered to a recording medium to which the dye is to be transferred, and after the ink jet ink composition is adhered to a transfer medium (such as paper) functioning as a transfer source, the dye is transferred from the transfer medium to the recording medium described above.

In the transfer recording method, after the sublimation dye is contained as one component of the ink jet ink composition, the composition is adhered once to the medium functioning as a transfer source, and the sublimation dye is then sublimated by vapor, heat, or the like, so that the recording medium to which recording is to be performed is dyed. As the composition used for the sublimation transfer as described above, for example, International Publication No. 2005-121263, JP-A-2004-107647, and JP-A-2004-107648 have disclosed compositions each containing a sublimation dye and glycerin and/or a sugar alcohol.

However, in the case of a sublimation transfer ink containing glycerin, since glycerin is evaporated by heating in the sublimation transfer and is then cooled in air to the condensation point thereof, because of fine small liquid droplets produced thereby, fumes may be generated in some cases. In addition, in the case of a sublimation transfer ink containing a sugar alcohol instead of glycerin, since the sugar alcohol has a high boiling point, a drying property at a transfer medium surface is made insufficient, and as a result, when the medium is wound up, an image may be transferred onto a rear surface thereof in some cases.

### SUMMARY

According to an aspect of the present disclosure, there is provided an ink jet ink composition comprising: a sublimation dye; a sugar alcohol having at least four OH groups; a diol having two or three carbon atoms; at least one permeable moisturizer selected from the group consisting of a glycol monoether, a diol having at least four carbon atoms, an amide, and a (poly)glyceryl ether; and glycerin at a content of one percent by mass or less with respect to a total mass of the ink jet ink composition.

According to another aspect of the present disclosure, there is provided an ink jet recording method comprising: a recording step of adhering the ink jet ink composition described above to a surface of a sheet-shaped recording medium; a transfer step in which after the sheet-shaped recording medium is disposed so that a recorded surface thereof overlaps a dyeing object, the sublimation dye is sublimation-transferred to the dyeing object by heating at a temperature of 150° C. to 220° C.; and after the transfer step is performed, a peeling step of peeling the sheet-shaped recording medium away from the dyeing object.

According to another aspect of the present disclosure, there is provided an ink jet recording method comprising: a recording step of adhering the ink jet ink composition described above to a sheet-shaped recording medium; a drying step of heating the sheet-shaped recording medium to which the ink jet ink composition is adhered to a temperature of 50° C. or more; and after the drying step is performed, a recovery step of winding the sheet-shaped recording medium in the form of a roll.

According to another aspect of the present disclosure, there is provided an ink jet recording apparatus comprising: an ink jet head to adhere the ink jet ink composition described above to a sheet-shaped recording medium; a heater to heat the sheet-shaped recording medium to a temperature of 50° C. or more; and a roller to wind the sheet-shaped recording medium in the form of a roll.

### BRIEF DESCRIPTION OF THE DRAWINGS

FIG. 1 is a table (Table 1) showing examples of a permeable moisturizer.

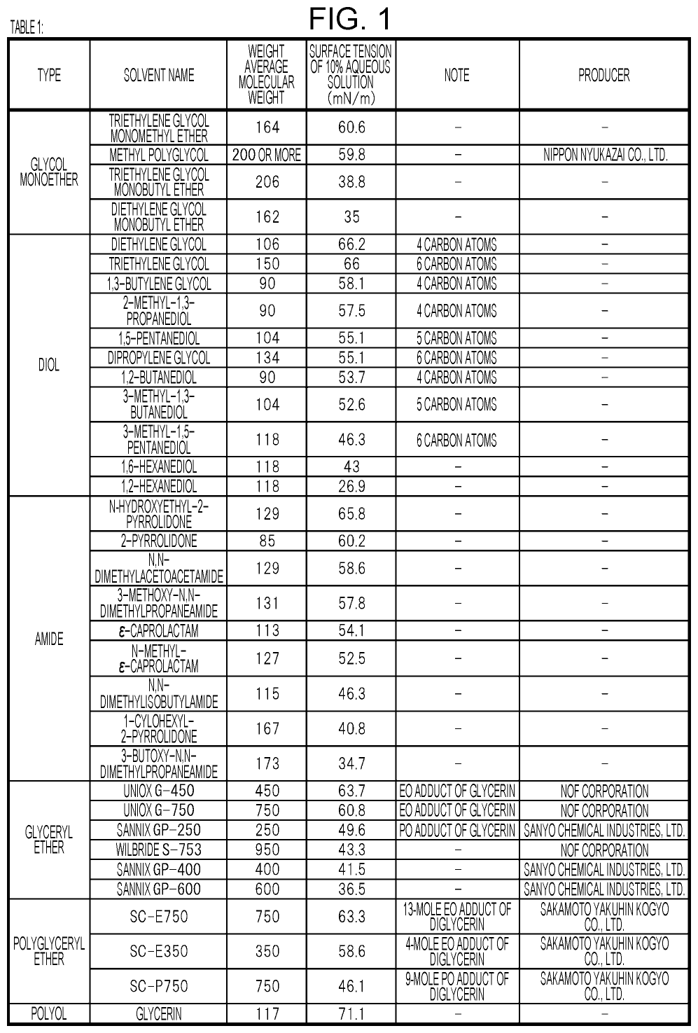

FIG. 2 is a schematic view showing one example of an ink jet recording apparatus.

FIG. 3 is Table 2 showing compositions of ink jet ink compositions of Examples.

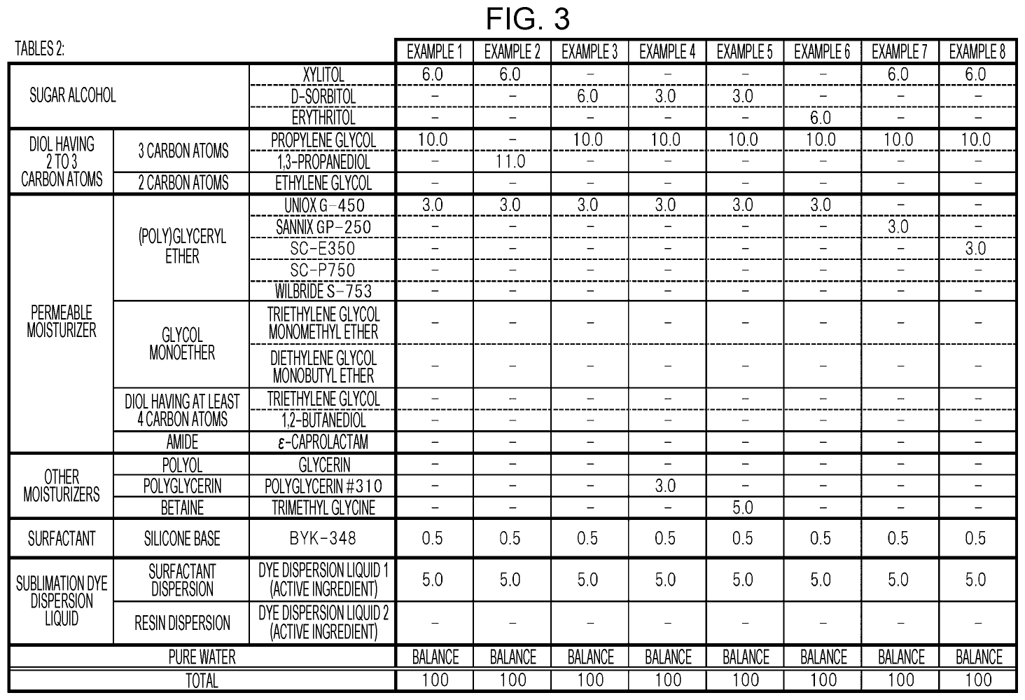

FIG. 4 is Table 3 showing compositions of ink jet ink compositions of Examples.

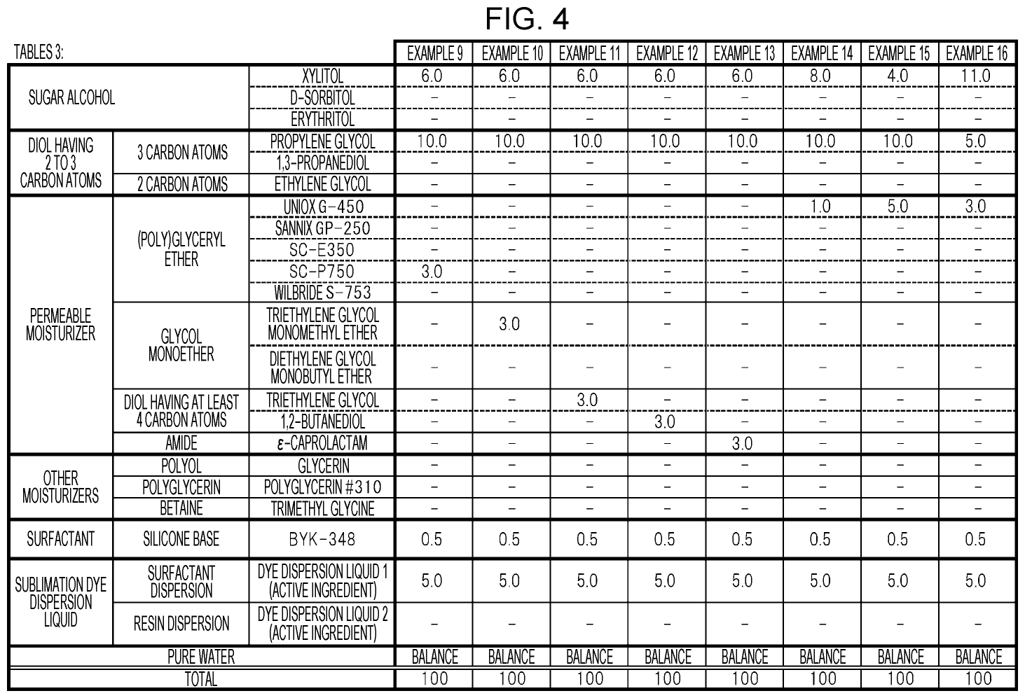

FIG. 5 is Table 4 showing compositions of ink jet ink compositions of Examples.

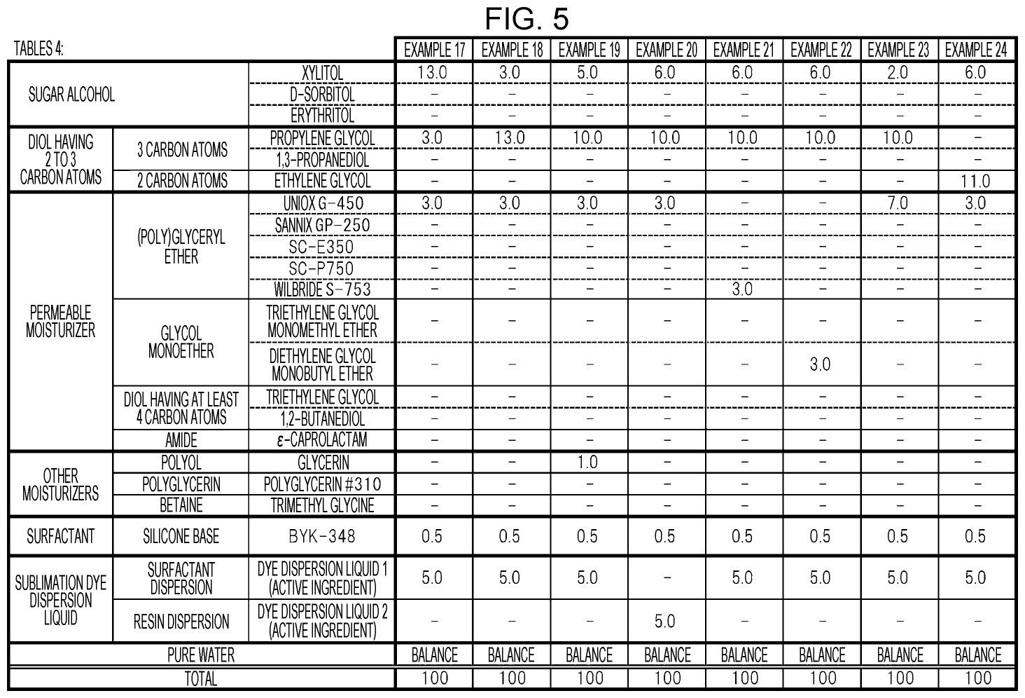

FIG. 6 is Table 5 showing compositions of ink jet ink compositions of Comparative Examples.

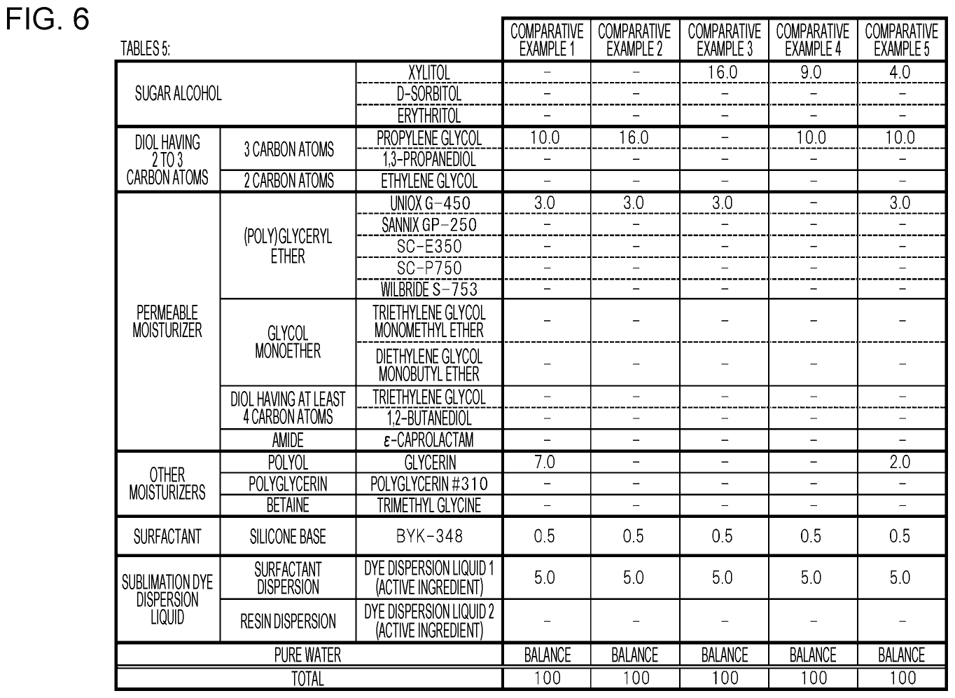

FIG. 7 is Table 6 showing evaluation results of Examples and Comparative Examples.

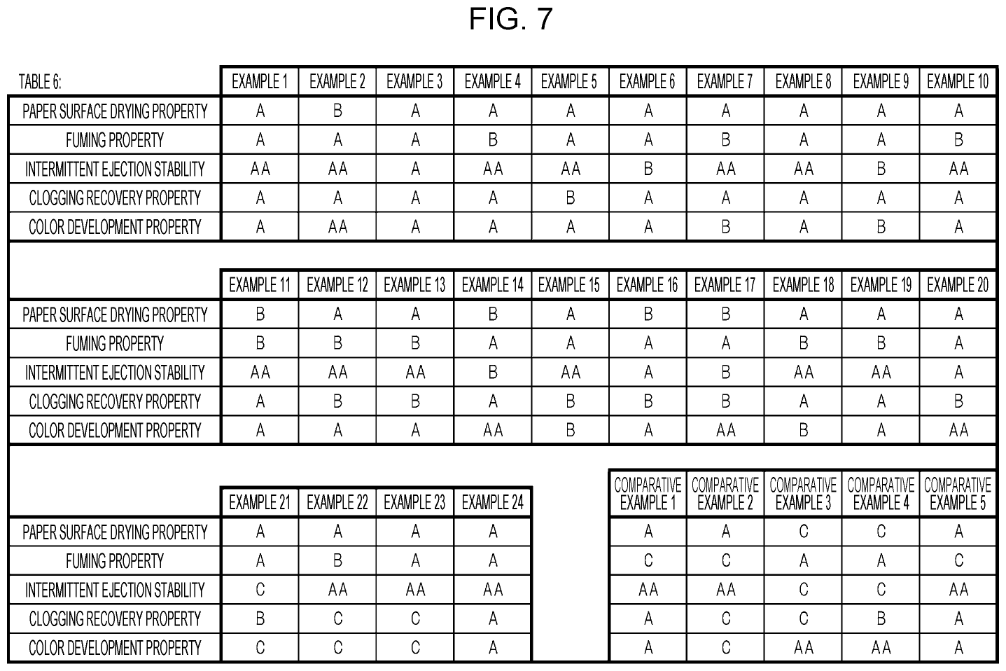

### DESCRIPTION OF EMBODIMENTS

Hereinafter, embodiments of the present disclosure will be described. The following embodiments are to describe examples of the present disclosure. The present disclosure is not at all limited to the following embodiments and also includes variously changed and/or modified embodiments to be performed without departing from the scope of the present disclosure. In addition, all the constituents to be described below are not always required to be essential constituents of the present disclosure.

### 1. Ink Jet Ink Composition

An ink jet ink composition according to this embodiment includes a sublimation dye, a sugar alcohol having at least four OH groups, a diol having two or three carbon atoms, at least one permeable moisturizer selected from the group consisting of a glycol monoether, a diol having at least four carbon atoms, an amide, and a (poly)glyceryl ether, and glycerin at a content of one percent by mass or less with respect to a total mass of the ink jet ink composition.

### 1.1. Sublimation Dye

The ink jet ink composition of this embodiment contains a sublimation dye (hereinafter, also referred to as “sublimable dye” or “sublimation type dye” in some cases). The sublimation dye is a dye to be preferably used for dyeing of hydrophobic synthetic fibers, such as polyester, nylon, or acetate fibers and is a compound insoluble or poorly soluble in water. In addition, the sublimation dye is a dye to be sublimated by heating. Although the sublimation dye used for the ink jet ink composition of this embodiment is not specifically limited, in particular, the following dyes may be mentioned by way of example.

As the sublimation dye, for example, a disperse dye and a solvent dye having the properties as described above may be used. As a concrete example of the dye as described above, for example, there may be mentioned C.I. Disperse Yellow 3, 7, 8, 23, 39, 51, 54, 60, 71, or 86; C.I. Disperse Orange 1, 1:1, 5, 20, 25, 25:1, 33, 56, or 76; C.I. Disperse Brown 2; C.I. Disperse Red 11, 50, 53, 55, 55:1, 59, 60, 65, 70, 75, 93, 146, 158, 190, 190:1, 207, 239, or 240; C.I. Vat Red 41; C.I. Disperse Violet 8, 17, 23, 27, 28, 29, 36, or 57; C.I. Disperse Blue 19, 26, 26:1, 35, 55, 56, 58, 64, 64:1, 72, 72:1, 81, 81:1, 91, 95, 108, 131, 141, 145, or 359; or C.I. Solvent Blue 36, 63, 105, or 111. Those dyes may be used alone, or at least two types thereof may be used in combination.

In view of storage stability of the ink jet ink composition, among the dyes mentioned above by way of example, the ink jet ink composition of this embodiment more preferably contains at least one selected from the group consisting of C.I. Disperse Yellow 3, 7, 8, 23, 51, 54, 60, 71, and 86; C.I. Disperse Orange 20, 25, 25:1, 56, and 76; C.I. Disperse Brown 2; C.I. Disperse Red 11, 53, 55, 55:1, 59, 60, 65, 70, 75, 146, 190, 190:1, 207, 239, and 240; C.I. Vat Red 41; C.I. Disperse Violet 8, 17, 23, 27, 28, 29, 36, and 57; C.I. Disperse Blue 26, 26:1, 55, 56, 58, 64, 64:1, 72, 72:1, 81, 81:1, 91, 95, 108, 131, 141, 145, and 359; and C.I. Solvent Blue 36, 63, 105, and 111.

Although all the sublimation dyes mentioned above by way of example are the compounds insoluble or poorly soluble in water, for example, when a dispersant which will be described later is used, the dye may be preferably dispersed in water as long as the concentration of the dispersant is in a specific range. In addition, the sublimation dyes mentioned above by way of example are slightly different from each other in terms of dispersibility and solubility. That is, depending on the type of sublimation dye, a preferable concentration range of the dispersant is changed, and the solubility by the dispersant is also changed.

The sublimation dyes mentioned above by way of example may be used alone, or at least two types thereof may be used in combination to form a mixed color.

A total content of the sublimation dye with respect to 100 percent by mass of the ink jet ink composition is 10 percent by mass or less, preferably 0.1 to 10 percent by mass, more preferably 0.2 to 9.0 percent by mass, and further preferably 0.3 to 8.0 percent by mass.

Since the content of the sublimation dye is 0.1 percent by mass or more, a dyed matter (including the transferred dye) to be obtained tends to have a more excellent color development property (OD value). In addition, since the content of the sublimation dye is 10 percent by mass or less, an ejection stability tends to be improved.

The sublimation dye may be dispersed by a dispersant. The dispersant has a function to disperse the above sublimation dye in the ink jet ink composition. Although the dispersant is not particularly limited, for example, an anionic dispersant, a nonionic dispersant, or a polymer dispersant (resin dispersant) may be mentioned.

As the anionic dispersant, a formalin condensate of an aromatic sulfonic acid may be preferably mentioned. As the “aromatic sulfonic acid” of the formalin condensate of an aromatic sulfonic acid, for example, there may be mentioned an alkylnaphthalene sulfonic acid, such as creosote oil sulfonic acid, cresol sulfonic acid, phenol sulfonic acid, β-naphthol sulfonic acid, methylnaphthalene sulfonic acid, or butylnaphthalene sulfonic acid; a mixture between β-naphthalene sulfonic acid and β-naphthol sulfonic acid, a mixture between cresol sulfonic acid and 2-naphthol-6-sulfonic acid, a lignin sulfonic acid, or a salt of one of those mentioned above.

In addition, as the anionic dispersant, a formalin condensate of β-naphthalene sulfonic acid, a formalin condensate of an alkylnaphthalene sulfonic acid, a formalin condensate of creosote oil sulfonic acid, or a salt of one of those mentioned above is preferable, and a sodium salt thereof is more preferable.

As the nonionic dispersant, for example, an ethylene oxide adduct of phytosterol or an ethylene oxide adduct of cholestanol may be mentioned.

Among those mentioned above, as a commercial product of the naphthalene sulfonic acid-based dispersant or the like, for example, there may be mentioned DEMOL NL, DEMOL MS, DEMOL N, DEMOL RN, DEMOL RN-L, DEMOL SC-30, DEMOL SN-B, DEMOL SS-L, DEMOL T, or DEMOL T-45 (trade name, manufactured by Kao Corporation).

In addition, as the polymer dispersant (also called “resin dispersant”), for example, there may be mentioned an acrylic-based resin, such as a polyacrylic acid, an acrylic acid-acrylonitrile copolymer, an acrylic acid-acrylate ester copolymer, a vinyl acetate-acrylate ester copolymer, a vinyl acetate-acrylic acid copolymer, a styrene-acrylic acid copolymer, a styrene-methacrylic acid copolymer, a styrene-methacrylic acid-acrylate ester copolymer, a styrene-α-methylstyrene-acrylic acid copolymer, a styrene-α-methylstyrene-acrylic acid-acrylate ester copolymer, or a vinylnaphthalene-acrylic acid copolymer, or a salt of one of those mentioned above; a styrene-based resin, such as a styrene-acrylic acid copolymer, a styrene-methacrylic acid copolymer, a styrene-methacrylic acid-acrylate ester copolymer, a styrene-α-methylstyrene-acrylic acid copolymer, a styrene-α-methylstyrene-acrylic acid-acrylate ester copolymer, a styrene-maleic acid copolymer, or a styrene-maleic anhydride copolymer, or a salt of one of those mentioned above; an urethane-based resin which is a linear and/or branched polymer compound (resin) including at least one urethane bond formed by a reaction between an isocyanate group and a hydroxy group and which may or may not have a crosslinked structure, or its salt; a poly(vinyl alcohol) or its salt; a poly(vinyl pyrrolidone) or its salt; a vinylnaphthalene-maleic acid copolymer or its salt; a vinyl acetate-maleate ester copolymer or its salt; or a vinyl acetate-crotonic acid copolymer or its salt.

As a commercial product of the styrene-based resin dispersant, for example, X-200, X-1, X-205, or X-220 (manufactured by Seiko PMC Corporation) may be mentioned. As a commercial product of the acrylic-based resin dispersant, for example, BYK-190, BYK-187, BYK-191, BYK-194N, or BYK-199 (manufactured by BYK) may be mentioned. In addition, as a commercial product of the urethane-based resin dispersant, for example, BYK-184, BYK-182, BYK-183, or BYK-185 (manufactured by BYK) may be mentioned.

The dispersant may be used alone, or at least two types thereof may be used in combination. A total content of the dispersant with respect to 100 percent by mass of the ink jet ink composition is 0.1 to 30 percent by mass, preferably 0.5 to 25 percent by mass, more preferably 1 to 20 percent by mass, and further preferably 1.5 to 15 percent by mass. Since the content of the dispersant is 0.1 percent by mass or more, a dispersion stability of the sublimation dye can be obtained. In addition, when the content of the dispersant is 30 percent by mass or less, the sublimation dye is not allowed to be excessively dissolved, and in addition, the viscosity can be controlled to be low.

Among the dispersants mentioned above by way of example, the resin dispersant, in particular, at least one selected from the group consisting of the acrylic-based resin, the styrene-based resin, and the urethane resin is more preferable. In addition, in the case described above, the dispersant more preferably has a weight average molecular weight of 500 or more. When the resin dispersant as described above is used as the dispersant, the dispersion stability of the sublimation dye can be further improved.

### 1.2. Sugar Alcohol

The ink jet ink composition of this embodiment contains a sugar alcohol having at least four OH groups (hereinafter, also referred to as “hydroxy groups” or “hydroxyl groups” in some cases). As an example of the sugar alcohol as described above, a sugar produced by reduction of a carbonyl group of an aldose or a ketose may be mentioned. As the sugar alcohol as described above, for example, there may be mentioned maltitol, lactitol, tetrytol, pentitol, hexitol, erythritol, sorbitol, xylitol, mannitol, or inositol. Among those mentioned above, at least one selected from the group consisting of D-sorbitol, erythritol, and D-mannitol is more preferable.

The molecular weights of some of the sugar alcohols mentioned above by way of example are shown below.
erythritol 122
xylitol 152
D-sorbitol 182
lactitol 344

The viscosities (unit: mPa·s) of the aqueous solutions at a concentration of 60 percent by mass of some of the sugar alcohols mentioned above by way of example are shown below.
xylitol 24.3
D-sorbitol 32.8

In addition, the “viscosity of the aqueous solution at a concentration of 60 percent by mass” was measured in a manner such that an aqueous solution at a concentration of 60 percent by mass was prepared from each sugar alcohol, and the viscosity thereof was measured at 20° C. and a shear rate of 200 s⁻¹ using a rheometer MCR302e (manufactured by Anton Paar). In addition, since having a high viscosity, erythritol failed to form an aqueous solution, and hence the measurement was not performed.

The surface tensions (unit: mN/m) of the aqueous solutions at a concentration of 10 percent by mass of some of the sugar alcohols mentioned above by way of example are shown below.
xylitol 74.1
D-sorbitol 73.5

In addition, the “surface tension of the aqueous solution at a concentration of 10 percent by mass” represents the value of the surface tension measured in a manner such that an aqueous solution at a concentration of 10 percent by mass was prepared from each sugar alcohol, and the surface tension thereof was measured at 20° C. using a surface tensiometer DY-300 (manufactured by Kyowa Interface Science Co., Ltd.).

The sugar alcohols mentioned above by way of example may be used alone, or at least two types thereof may be used in combination. Since the ink jet ink composition contains the sugar alcohol, a fuming property can be suppressed, and in addition, a clogging recovery property and the color development property of the image can be made preferable.

In addition, the viscosity of the aqueous solution at a concentration of 60 percent by mass of the sugar alcohol is preferably 35 mPa·s or less, more preferably 33 mPa·s or less, and further preferably 30 mPa·s or less. Since the viscosity of the aqueous solution at a concentration of 60 percent by mass of the sugar alcohol is 35 mPa·s or less, the influence of an evaporative thickening property of the sugar alcohol can be further reduced, and an intermittent ejection stability can also be made more excellent.

A content of the sugar alcohol with respect to the total mass of the ink jet ink composition is preferably 3 to 15 percent by mass, more preferably 3 to 13 percent by mass, even more preferably 3 to 11 percent by mass, and further preferably 4 to 7 percent by mass. When the content of the sugar alcohol is in the range described above, the clogging recovery property, the color development property, and the intermittent ejection stability can be made more preferable at the same time.

### 1.3. Diol Having Two or Three Carbon Atoms

The ink jet ink composition according to this embodiment contains a diol having two or three carbon atoms. As the diol having two or three carbon atoms, for example, ethylene glycol, 1,2-propanediol (propylene glycol), or 1,3-propanediol may be mentioned. Among those mentioned above, propylene glycol is more preferably used. In addition, in the ink jet ink composition, at least two types of those diols may be contained in combination.

Since the ink jet ink composition contains the diol having two or three carbon atoms, a paper surface drying property is improved, and at the same time, the influence of the evaporative thickening property can be further reduced, and the intermittent ejection stability can also be made more excellent.

In addition, a content of the diol having two or three carbon atoms with respect to the total mass of the ink jet ink composition is preferably 5 to 15 percent by mass, more preferably 6 to 14 percent by mass, and further preferably 7 to 13 percent by mass. In the ink jet ink composition, when the content of the diol having two or three carbon atoms is in the range as described above, the generation of fumes can be further suppressed, and the paper surface drying property and the intermittent ejection stability are also made more excellent.

### 1.4. Permeable Moisturizer

The ink jet ink composition according to this embodiment contains at least one permeable moisturizer selected from the group consisting of a glycol monoether, a diol having at least four carbon atoms, an amide, and a (poly)glyceryl ether.

Since the ink jet ink composition contains the permeable moisturizer, the drying property of the image formed by the ink jet ink composition can be enhanced, and at the same time, the intermittent ejection stability can also be made preferable. In addition, in this specification, although the permeable moisturizer will be described separately from a moisturizer, the permeable moisturizer is not always required to have permeability, and moisturizers having low or no permeability are also each called the permeable moisturizer.

In Table 1, the permeable moisturizers are shown by way of example.

After an aqueous solution at a concentration of 10 percent by mass was prepared using each permeable moisturizer, the surface tension thereof was measured using a surface tensiometer DY-300 (manufactured by Kyowa Interface Science Co., Ltd.), and the result thus obtained is shown in Table 1.

The ink jet ink composition may also contain a permeable moisturizer other than those shown in Table 1 by way of example. In addition, at least two types of permeable moisturizers may also be used in combination. The surface tension of the aqueous solution at a concentration of 10 percent by mass of the permeable moisturizer is preferably 45 to 67 mN/m, more preferably 46 to 65 mN/m, and further preferably 50 to 64 mN/m.

When the surface tension of the aqueous solution at a concentration of 10 percent by mass is in the range as described above, the color development property, the intermittent ejection stability, the paper surface drying property, and the clogging recovery property of the ink jet ink composition are made more excellent. In addition, when being controlled in the range as described above, the surface tension described above is more appropriate; hence, the permeability is more appropriate, and the color development property of an image to be obtained can also be made more preferable. Furthermore, the viscosity and/or the evaporative thickening property is also made more preferable, and as a result, the clogging recovery property and/or the intermittent ejection stability is also made more excellent.

A content of the permeable moisturizer with respect to the total mass of the ink jet ink composition is preferably 10 percent by mass or less, more preferably 7 percent by mass or less, and further preferably 5 percent by mass or less. In addition, a lower limit of the content of the permeable moisturizer is preferably 0.3 percent by mass or more, more preferably 0.5 percent by mass or more, and further preferably 1 percent by mass or more. Since the permeable moisturizer is contained as described above, the clogging recovery property of the ink jet ink composition and the color development property of the image can be made more excellent. In addition, the storage stability of the ink jet ink composition can also be made excellent.

The permeable moisturizer preferably includes a (poly)glyceryl ether. As an example of the (poly)glyceryl ether, for example, an alkylene oxide adduct of glycerin or a polyglycerin may be mentioned. The (poly)glyceryl ether, that is, a polyglyceryl ether or a glyceryl ether, has a lower fuming property, and hence, the generation of fumes is more likely to be suppressed in the transfer. For example, by UNIOX G-450, UNIOX G-750, SC-E750, SC-E350, and SC-P750, which are shown in Table 1 by way of example, the following results can be obtained.

The fuming property of an aqueous solution at a concentration of 30 percent by mass was evaluated as described below. After an aqueous solution at a concentration of 30 percent by mass was formed from each (poly)glyceryl ether, and 10 liquid droplets thereof were dripped on a 100%-polyester cloth Carl Dry (manufactured by Toray Industries, Inc.) using a polymer-made dropper, a pressure of 465 g/cm² was then applied at 200° C. for 40 seconds using a desktop automatic sublimation transfer press machine AF-54TEN (manufactured by Itsumi Co., Ltd.), and whether or not fumes were generated was evaluated by visual inspection. As a result, by UNIOX G-450, UNIOX G-750, SC-E750, SC-E350, and SC-P750, no fumes were generated.

The effects as described above are believed to be obtained partially due to the molecular weight size of the (poly)glyceryl ether. From the point described above, when the (poly)glyceryl ether is used, the weight average molecular weight thereof is preferably 280 to 900, more preferably 300 to 800, and further preferably 350 to 750.

In addition, in view of the viscosity of the solution, the increase rate thereof when the solution is dried, and the like, an upper limit of the weight average molecular weight is preferably in the range described above.

### 1.5. Glycerin

The ink jet ink composition of this embodiment contains glycerin at a content of zero percent by mass or more and one percent by mass or less with respect to the total mass thereof. The ink jet ink composition contains no glycerin at a content of more than one percent by mass with respect to the total mass thereof.

In the ink jet ink composition, glycerin is not contained preferably at a content of more than 0.5 percent by mass and more preferably at a content of more than 0.1 percent by mass. In addition, glycerin may or may not be contained in the ink jet ink composition, and even when glycerin is contained, the content thereof is not more than that described above.

When the content of glycerin is in the range described above, the ink jet ink composition is not likely to generate fumes, and an excellent paper surface drying property can be obtained.

### 1.6. Other Components

Besides the components described above, the ink jet ink composition may also contain the following components.

### 1.6.1. Surfactant

The ink jet ink composition may also contain a surfactant. Although the surfactant is not particularly limited, for example, an acetylene glycol-based surfactant, a fluorine-based surfactant, or a silicone-based surfactant may be mentioned.

Although the acetylene glycol-based surfactant is not particularly limited, for example, there may be mentioned Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, or DF110D (trade name, manufactured by Air Products Japan); Olfine B, Y, P, A, STG, SPC, E1004, E1010, PD-001, PD-002W, PD-003, PD-004, EXP.4001, EXP. 4036, EXP.4051, AF-103, AF-104, AK-02, SK-14, or AE-3 (trade name, manufactured by Nissin Chemical Industry Co., Ltd.); or Acetylenol E00, EOOP, E40, or E100 (trade name, manufactured by Kawaken Fine Chemicals Co., Ltd.).

As the fluorine-based surfactant, a fluorine-modified polymer is preferably used, and as a concrete example, BYK-340 (trade name, manufactured by BYK Japan KK) may be mentioned.

Although the silicone-based surfactant is not particularly limited, a polysiloxane-based compound is preferably mentioned. The polysiloxane-based compound is not particularly limited, and for example, a polyether modified organosiloxane may be mentioned. As a commercial product of the polyether modified organosiloxane, for example, there may be mentioned BYK-306, BYK-307, BYK-333, BYK-341, BYK-345, BYK-346, or BYK-348 (trade name, manufactured by BYK Japan KK); KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.); or Silface SAG503A or Silface SAG014 (trade name, manufactured by Nissin Chemical Industry Co., Ltd.).

The surfactants mentioned above may be used alone, or at least two types thereof may be used in combination. When the surfactant is contained, a content thereof

with respect to the total mass of the ink jet ink composition is preferably set to 0.1 to 1.5 percent by mass.

### 1.6.2. Polyglycerin and Betaine

The ink jet ink composition may also contain at least one selected from the group consisting of a polyglycerin and a betaine. Although the polyglycerin and the betaine have properties as the moisturizer, in this specification, the polyglycerin and the betaine are regarded as different from the permeable moisturizer described above and will be handled separately therefrom.

As the polyglycerin, for example, there may be mentioned Diglycerin S (manufactured by Sakamoto Yakuhin Kogyo Coo., Ltd.) (weight average molecular weight: 166, viscosity of 60%-aqueous solution: 20.8, surface tension of 10%-aqueous solution: 72.5), R-PG (manufactured by Sakamoto Yakuhin Kogyo Coo., Ltd.) (weight average molecular weight: 240, viscosity of 60%-aqueous solution: 29), or Polyglycerin #310 (manufactured by Sakamoto Yakuhin Kogyo Coo., Ltd.) (weight average molecular weight: 310, viscosity of 60%-aqueous solution: 22.8).

The betaine represents a compound which has a positive charge and a negative charge in the same molecule at positions not adjacent to each other, which has not a dissociable hydrogen bonded to the atom having a positive charge, which is able to form an intramolecular salt, and which has no charge as the whole molecule. In this embodiment, in the betaine, the positively charged portion is preferably a quaternary ammonium cation.

The betaine is not particularly limited, and for example, there may be mentioned a trialkylglycine, such as trimethylglycine or triethylglycine, γ-butyrobetaine, homarine, trigonelline, carnitine, homoserine betaine, valine betaine, lysine betaine, ornithine betaine, alanine betaine, stachydrine, or glutamic acid betaine. Among those mentioned above, as the glycine contained in the ink jet ink composition, a trialkylglycine is preferably selected, and trimethylglycine is more preferably contained. The trialkylglycine is a compound in which three alkyl groups are bonded to the nitrogen atom of the glycine. Accordingly, the clogging recovery property tends to be further improved. In addition, the betaine may be used alone, or at least two types thereof may be used in combination.

When the polyglycerin and the betaine are used, a content thereof in total with respect to the total mass of the ink jet ink composition is preferably 2.5 to 9.5 percent by mass, more preferably 3 to 8 percent by mass, and further preferably 4 to 8 percent by mass.

In addition, the polyglycerin may contain glycerin as an impurity in some cases, and when a large amount is added, the fuming property may be generated in some cases. In addition, when the betaine is a solid, and a large amount thereof is added, the clogging recovery property may be degraded in some cases. From the points as described above, the content described above is preferably set in the range described above.

Since the polyglycerin and the betaine both have a low evaporative thickening property, when the ink jet ink composition contains at least one of the polyglycerin and the betaine, by a small addition amount thereof, the intermittent ejection stability can be improved. In addition, flight bending and non-ejection of the ink jet ink composition caused by drying thereof at a nozzle of the ink jet head can also suppressed, and hence, the clogging recovery property can be made excellent.

### 1.6.3. Water

The ink jet ink composition of this embodiment may be an aqueous composition containing water. The “aqueous” composition indicates a composition using water as one primary solvent. As the water, for example, there may be mentioned pure water, such as ion exchange water, ultrafiltration water, reverse osmosis water, or distilled water, or water, such as ultrapure water, in which ionic impurities are reduced as much as possible. In addition, when water sterilized, for example, by UV radiation or addition of hydrogen peroxide is used, in the case in which the ink jet ink composition is stored for a long time, generation of bacteria and fungi can be suppressed.

A content of the water with respect to the total mass (100 percent by mass) of the ink jet ink composition is 30 percent by mass or more, preferably 40 percent by mass or more, more preferably 45 percent by mass or more, and further preferably 50 percent by mass or more. In addition, an upper limit of the content of the water with respect to the total mass (100 percent by mass) of the ink jet ink composition is preferably 97 percent by mass or less, more preferably 90 percent by mass or less, even more preferably 85 percent by mass or less, and further preferably 80 percent by mass or less.

### 1.6.4. Other Components

The ink jet ink composition of this embodiment may also contain, if needed, various types of additives, such as an organic solvent, a chelating agent, an antirust agent, a fungicide, an antioxidant, a reduction inhibitor, and/or an evaporation promoter.

### 1.7. Production and Physical Properties

In order to further improve the quality of the image formed by an ink jet method, the surface tension (static surface tension) of the ink jet ink composition of this embodiment at 20° C. is preferably 18 to 40 mN/m, more preferably 20 to 35 mN/m, and further preferably 22 to 33 mN/m. In addition, the measurement of the surface tension is performed, for example, using an automatic surface tensiometer CBVP-Z (trade name, manufactured by Kyowa Interface Science Co., Ltd.) in a manner such that a surface tension measured when a platinum plate is wetted with the ink jet ink composition in an environment at 20° C. is confirmed.

From the same point as described above, the viscosity of the ink jet ink composition at 20° C. is preferably 3 to 10 mPa·s and more preferably 3 to 8 mPa·s. In addition, the measurement of the viscosity is performed in an environment at 20° C., for example, using a viscoelastic tester MCR-300 (trade name, manufactured by Pysica).

The ink jet ink composition can be obtained in a manner such that the components described above are mixed together in an arbitrary order, and if needed, impurities are then removed by filtration or the like. As a mixing method of the components, a method in which the materials are sequentially charged in a container equipped with a stirring device, such as a mechanical stirrer or a magnetic stirrer, and are then stirred and mixed together is preferably used. As a filtration method, for example, a centrifugal filtration and/or a filter filtration may be performed, if needed.

### 1.8. Operation Effect

According to the ink jet ink composition of this embodiment, the sugar alcohol having at least four OH groups is not likely to be evaporated at a temperature of up to 220° C. and is also not likely to fume when being heated. In addition, according to this ink jet ink composition, since the diol having two or three carbon atoms, which has a high drying property and a low viscosity, and the permeable moisturizer are also used together, a low fuming property and a preferable paper surface drying property can both be obtained at the same time. Furthermore, according to this ink jet ink composition, since the content of glycerin is one percent by mass or less, the fuming can be suppressed.

### 2. Ink Jet Recording Method

### 2.1. First Embodiment

An ink jet recording method according to this embodiment includes a recording step of adhering the ink jet ink composition described above to a surface of a sheet-shaped recording medium (intermediate transfer medium), a transfer step in which after the sheet-shaped recording medium (intermediate transfer medium) is disposed so that a recorded surface thereof overlaps a dyeing object (medium to be recorded), the sublimation dye is sublimation-transferred to the dyeing object (medium to be recorded) by heating at a temperature of 150° C. to 220° C., and after the transfer step is performed, a peeling step of peeling the sheet-shaped recording medium (intermediate transfer medium) away from the dyeing object (medium to be recorded).

The ink jet ink composition described above can be preferably applied to a dyeing method (sublimation transfer ink jet recording method) performed for a cloth or the like using sublimation transfer. The ink jet recording method of this embodiment may also be called a method for manufacturing a dyed matter.

The ink jet recording method (method for manufacturing a dyed matter) of this embodiment includes a step of adhering an ink jet ink composition to a surface of a recording medium (intermediate transfer medium), a step of disposing a dyeing object (medium to be recorded) at a recorded surface of the recording medium, a step of heating the recording medium and the dyeing object, and a peeling step of peeling the recording medium away from the dyeing object. In other words, the ink jet recording method (method for manufacturing a dyed matter) of this embodiment includes a recording step of applying the ink jet ink composition described above to a surface of the recording medium using an ink jet method, a transfer step in which while the recording medium to which the ink composition is applied is disposed so that a recorded surface thereof faces a dyeing surface of the dyeing object, the recording medium to which the ink composition is applied is heated so as to transfer the sublimation dye to the dyeing object, and after the transfer step is performed, a peeling step of peeling the recording medium away from the dyeing object.

Hereinafter, the steps described above will be described in detail.

### Recording Step

In this step, by using an ink jet method, the ink jet ink composition is applied to a surface of the intermediate transfer medium (first recording medium). The ejection of the ink jet ink composition by an ink jet method may be performed by using a liquid droplet ejection apparatus (such as an ink jet recording apparatus which will be described later).

As a liquid droplet ejection method (ink jet type method), although a piezoelectric method, a method in which an ink is ejected using foam (bubbles) generated by heating the ink, or the like may be used, for example, in order to enable the ink composition not to easily deteriorate, a piezoelectric method is preferable. In addition, according to the study by the present inventor, it has been known that in a thin-film piezoelectric type recording head, a share rate applied to the ink jet ink composition is approximately 100 s⁻¹, and this share rate is a more preferable rate for the ink jet ink composition of this embodiment.

As the intermediate transfer medium, a sheet-shaped recording medium may be mentioned, and for example, although paper, such as regular paper, or a recording medium (called ink jet exclusive paper, coated paper, or the like) having an ink receiving layer may be used, paper having an ink receiving layer formed of inorganic particles such as silica is more preferable. Accordingly, an intermediate recorded matter to suppress bleeding or the like on the recorded surface is obtained in the process of drying the ink jet ink composition applied to the intermediate transfer medium. In addition, when the medium as described above is used, the sublimation dye is more easily allowed to stay on the recorded surface, and hence in the following transfer step, the sublimation of the sublimation dye can be more efficiently performed.

In this step, at least two types of ink jet ink compositions may also be used in combination. Accordingly, for example, the color gamut to be displayed can be made wider.

### Transfer Step

Subsequently, the heating is performed while the recorded surface of the intermediate transfer medium to which the ink composition is applied is disposed to face the dyeing object (that is, while a second recording medium is disposed at the recorded surface of the first recording medium), so that the sublimation dye which forms the ink jet ink composition is transferred to the dyeing object. Accordingly, a dyed matter including the dyeing object formed from a cloth or the like is obtained.

A heating temperature in this step is 150° C. to 220° C. and preferably 160° C. to 210° C. Accordingly, sufficient energy to transfer the sublimation dye to the dyeing object can be applied, and hence, the productivity of the dyed matter can be made excellent.

Although depending on the heating temperature, a heating time in this step is 30 to 90 seconds and preferably 45 to 60 seconds. Accordingly, sufficient energy to transfer the sublimation dye to the dyeing object can be applied, and hence, the productivity of the dyed matter can be made excellent.

In addition, in this step, although the heating may be performed while the intermediate transfer medium to which the ink composition is applied is disposed to face the dyeing object, the heating is more preferably performed while the intermediate transfer medium and the dyeing object are closely in contact with each other. Accordingly, for example, a clearer image can be recorded (dyed) on the second recording medium.

As the dyeing object, for example, a cloth (such as a hydrophobic fibrous cloth) or a sheet-shaped material, such as a resin (plastic) film, may be preferably used, and in addition, a three-dimensional shape, such as a spherical or a rectangular parallelepiped shape, may also be used besides the sheet shape described above.

In addition, as the dyeing object, for example, besides the materials formed from resins or plastics, glass, metal, or ceramic materials may also be used. As fibers forming the cloth used as the dyeing object, for example, there may be mentioned polyester fibers, nylon fibers, triacetate fibers, diacetate fibers, polyamide fibers, or blended fibers formed using at least two types of fibers mentioned above. In addition, blended fibers formed using at least one of those mentioned above and regenerated fibers, such as rayon fibers, or natural fibers, such as cotton, silk, or wool fibers, may also be used.

In addition, as the resin (plastic) film to be used as the dyeing object, for example, there may be mentioned a polyester film, a polyurethane film, a polycarbonate film, a poly (phenylene sulfide) film, a polyimide film, or a poly (amide imide) film. The resin (plastic) film may be a laminate in which at least two layers are laminated to each other or may be formed from a gradient material in which the composition of the material is gradually changed.

### Peeling Step

In this step, after the image is transferred by the transfer step, the recording medium (intermediate transfer medium) is peeled away from the dyeing object (medium to be recorded). A peeling method is not particularly limited and may be performed using an appropriate device.

According to the ink jet recording method of this embodiment, since the sublimation transfer temperature is 150° C. to 220° C., the evaporation of the sugar alcohol is suppressed, and the generation of fumes is also suppressed.

### 2.2. Second Embodiment

An ink jet recording method according to this embodiment includes a recording step of adhering the ink jet ink composition described above to a sheet-shaped recording medium, a drying step of heating the recording medium to which the ink jet ink composition is adhered to a temperature of 50° C. or more, and after the drying step is performed, a recovery step of winding the recording medium in the form of a roll.

The recording step in the ink jet recording method of this embodiment is similar to the recording step of the first embodiment, and hence, description thereof will be omitted.

### Drying Step

In the drying step, the recording medium (intermediate transfer medium) to which the ink jet ink composition is adhered in the recording step is heated to a temperature of 50° C. or more. A heating method is not particularly limited, and for example, the method may be performed using an after heater which will be described in the following ink jet recording apparatus.

### Recovery Step

In the recovery step, the recording medium (intermediate transfer medium) dried in the drying step is wound in the form of a roll. The recovery step can be performed using an appropriate winding device.

### Other Steps

The ink jet recording method of this embodiment may further include a transfer step, a peeling step, and the like. Since the transfer step and the peeling step are similar to those described in the above first embodiment, descriptions thereof will be omitted. In this embodiment, after being wound in the form of a roll, the intermediate transfer medium is used in the transfer step. Accordingly, the degree of freedom of the process to obtain the printed matter can be increased.

According to the ink jet recording method of this embodiment, by the drying step in which the heating is performed to a temperature of 50° C. or more, since the diol is evaporated, the paper surface drying property is made preferable, and the fuming in the transfer step can also be suppressed. In addition, since the ink jet ink composition described above is used, the paper surface drying property in the drying step in which the temperature is increased to 50° C. or more is also preferable, and even when the recording medium is wound in the form of a roll, bleed-through is not likely to occur.

### 3. Ink Jet Recording Apparatus

The ink jet ink composition described above can be preferably used for an ink jet recording apparatus. The ink jet recording apparatus is not particularly limited as long as including at least an ink receiving container (cartridge, tank, or the like) to receive the ink jet ink composition described above and a recording head connected thereto and being able to form an image on an intermediate transfer medium (transfer paper or the like) by ejecting the ink jet ink composition described above from the recording head.

As the ink jet recording apparatus of this embodiment, either a serial type or a line type may be used. In those types of ink jet recording apparatuses, a recording head is mounted, and while a relative positional relationship between the recording medium (intermediate transfer medium) and the recording head is changed, liquid droplets of the ink jet ink composition each having a predetermined volume (mass) are ejected from nozzle holes of the recording head at a predetermined timing (intermittently) and are adhered to the recording medium (intermediate transfer medium), so that a predetermined image can be formed.

In addition, in general, in the serial type ink jet recording apparatus, a transport direction of the recording medium and a direction of a reciprocal movement of the recording head are intersected, and by the combination between the reciprocal movement of the recording head and the transport movement (including the reciprocal movement) of the recording medium, the relative positional relationship between the recording medium and the recording head is changed. In addition, in the case described above, in general, a plurality of nozzle holes (holes to eject the ink composition) is disposed in the recording head, and at least one line (nozzle line) of the nozzle holes is formed along the transport direction of the recording medium. In addition, in the recording head, in accordance with the number and the type of ink compositions, a plurality of nozzle lines may be formed in some cases.

In addition, in general, in the line type ink jet recording apparatus, the recording head performs no reciprocal movement, and the relative positional relationship between the recording medium and the recording head is changed by the transport of the recording medium. In the case described above, in general, a plurality of nozzle holes is also disposed in the recording head, and at least one line (nozzle line) of the nozzle holes is formed along the direction intersecting the transport direction of the recording medium.

Although the ink jet recording method uses the serial type or the line type ink jet recording apparatus, the type is not particularly limited as long as the ink composition can be ejected in the form of liquid droplets from fine nozzle holes and can be adhered to the recording medium. As a liquid droplet ejection method (ink jet type method), for example, although a piezoelectric method or a method in which an ink is ejected using foam (bubbles) generated by heating the ink may be used, in order to enable the ink composition not to easily deteriorate, a piezoelectric method is preferable.

In the ink jet recording apparatus used in this embodiment, for example, known constituents, such as a heating unit, a drying unit, a roll unit, and/or a winding device, may also be used without any particular limitations.

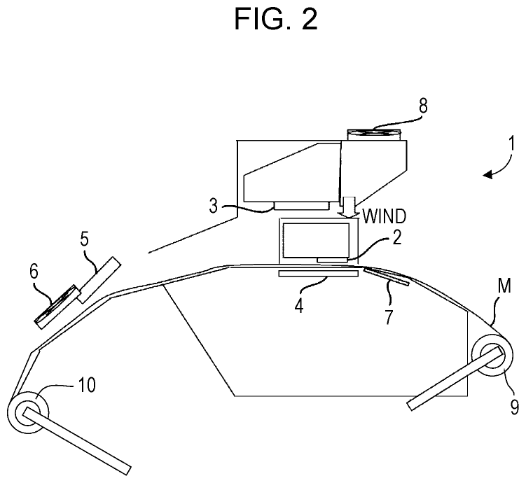

Hereinafter, one example of a recording apparatus preferably used for the ink jet recording method of this embodiment will be described. FIG. 2 is a schematic cross-sectional view showing an ink jet recording apparatus according to one embodiment. As shown in FIG. 2, a recording apparatus 1 includes a supply roll 9, a recording head 2, an IR heater 3, a platen heater 4, an after heater 5, a cooling fan 6, a pre-heater 7, a ventilation fan 8, and a winding roll 10.

The recording head 2 is a head to eject an ink jet ink composition to a recording medium M (intermediate transfer medium) fed from the supply roll 9. For the recoding head 2, a known method may be used. As one example of the known method, for example, a head to eject liquid droplets using vibration of a piezoelectric element, that is, a head to form ink droplets by mechanical deformation of a piezoelectric element, may be mentioned. As the recording head 2, for example, a head capable of ejecting multi-size dots of the ink jet ink composition from one nozzle may be mentioned.

In the above drying step, although the recording medium (intermediate transfer medium) is heated after the recording step, by the recording apparatus 1, the step described above may be performed using the after heater 5. In addition, although not shown in the figure, a device, such as a hot wind mechanism (not shown) and/or a constant temperature bath (not shown), may also be used. The after heater 5 is a heater to heat and dry the recording medium (intermediate transfer medium) to which the ink jet ink composition is adhered. Since the after heater 5 heats the recording medium (intermediate transfer medium) on which an image is recorded, moisture and the like contained in the ink jet ink composition can be more rapidly scattered by evaporation, and as a result, for example, bleeding can be suppressed. The after heater 5 heats the recording medium (intermediate transfer medium) to a temperature of preferably 50° C. or more and more preferably 60° C. to 110° C.

In addition, the recording apparatus 1 also includes the IR heater 3 to directly heat the recording head 2 and the platen heater 4 to heat the recording head 2 with the recording medium (intermediate transfer medium) interposed therebetween.

When the IR heater 3 is used, the recording medium (intermediate transfer medium) can also be heated from a recording head 2 side. Accordingly, although the recording head 2 is also liable to be simultaneously heated, compared to the case in which the rear surface of the recording medium (intermediate transfer medium) is heated by the platen heater 4 or the like, the temperature of the recording medium (intermediate transfer medium) can be increased without receiving the influence of the thickness thereof. In addition, when the platen heater 4 is used, the recording medium (intermediate transfer medium) can be heated at a side opposite to the recording head 2 side. Accordingly, the recording head 2 is relatively unlikely to be heated.

In addition, the above “recording medium (intermediate transfer medium) is heated” indicates the case in which the temperature of the recording medium (intermediate transfer medium) is increased to a desired temperature and is not limited to the case in which the recording medium (intermediate transfer medium) is directly heated. The recording apparatus 1 may also include the cooling fan 6. After the drying step is performed, when the ink composition on the recording medium (intermediate transfer medium) is cooled by the cooling fan 6, a coating film preferably tends to be formed on the recording medium (intermediate transfer medium) with good adhesion.

In addition, the recording apparatus 1 may also include the pre-heater 7 to pre-heat the recording medium (intermediate transfer medium) in advance before the ink composition is ejected to the recording medium (intermediate transfer medium). Furthermore, the recording apparatus 1 may also include the ventilation fan 8 to efficiently dry the ink composition adhered to the recording medium (intermediate transfer medium).

After the recording step is performed, and the drying step is then performed, the recording medium M (intermediate transfer medium) is wound by the winding roll 10. In addition, the recording apparatus 1 may not include the winding roll 10, and for example, the recording medium M (intermediate transfer medium) processed through the drying step may be transported to a transfer device (not shown) and may be further processed by a transfer step and a peeling step.

### 4. EXAMPLES AND COMPARATIVE EXAMPLES

Hereinafter, although the present disclosure will be described in detail with reference to Examples, the present disclosure is not limited to the following Examples. Hereinafter, unless otherwise particularly noted, “part(s)” and “%” are on a mass basis. In addition, unless otherwise particularly noted, the evaluation was performed in an environment at a temperature of 25.0° C. and a relative humidity of 40.0%.

### 4.1. Preparation of Ink Jet Ink Composition

After components were charged in a container to obtain one of the compositions shown in Tables 2 to 5 and were then mixed and stirred for 2 hours by a magnetic stirrer, filtration was performed using a membrane filter having a pore size of 5 μm, and by the same way as described above, the ink jet ink compositions of Examples 1 to 24 and Comparative Examples 1 to 5 were obtained. In addition, the numerical value shown in the table represents percent by mass.

In Tables 2 to 5, details of the components described by trade names, abbreviations, and the like are as shown below.
UNIOX G-450: glyceryl ether, manufactured by NOF Corporation
SANNIX GP-250: glyceryl ether, manufactured by Sanyo Chemical Industries, Ltd.
SC-E350: polyglyceryl ether, manufactured by Sakamoto Yakuhin Kogyo Co., Ltd.
SC-P750: polyglyceryl ether, manufactured by Sakamoto Yakuhin Kogyo Co., Ltd.
WILBRIDE S-753: glyceryl ether, manufactured by NOF Corporation
Polyglycerin #310: polyglycerin, manufactured by Sakamoto Yakuhin Kogyo Co., Ltd.
BYK-348: silicone-based surfactant, manufactured by BYK Japan KK

The dye dispersion liquid 1 shown in the table was prepared as described below.

### Dye Dispersion Liquid 1 (Surfactant Dispersion)

A dispersion treatment was performed by a sand mill using glass beads having a diameter of 0.2 mm for approximately 15 hours under cooling conditions on a mixture containing 30 parts of Kayaset Red B (manufactured by Nippon Kayaku Co., Ltd., C.I. Disperse Red 60) as the sublimation dye, 45 parts of Lavelin ®W-40 (manufactured by DSK Co., Ltd., 40%-aqueous solution of a formalin condensate of creosote oil sulfonate) as an anionic dispersant, 2 parts of NIKKOLRTMBPS-30 (manufactured by Nikko Chemicals Co., Ltd., a 30-mole EO (ethylene oxide) adduct of phytosterol) as a nonionic dispersant, and 23 parts of ion exchange water. After 100 parts of ion exchange water was added to the liquid obtained by the above dispersion treatment so as to have a dye content of 15%, filtration was performed using glass fiber filter paper GC-50 (manufactured by Toyo Filter Paper Co., Ltd., filter pore diameter: 0.5 μm), so that the dye dispersion liquid 1 was obtained.

The dye dispersion liquid 2 shown in the table was prepared as described below.

### Dye Dispersion Liquid 2 (Resin Dispersion)

After 20 parts of Joncryl ®678 (manufactured by BASF) was charged to a mixture containing 3.2 parts of 48%-lithium hydroxide, 56.8 parts of ion exchange water, and 20 parts of propylene glycol, the temperature was increased to 90° C. to 120° C., and stirring was performed for 5 hours, so that an emulsion liquid of Joncryl ®678 was obtained. A dispersion treatment was performed by a sand mill using glass beads having a diameter of 0.2 mm for approximately 15 hours under cooling conditions on a mixture containing 30 parts of Kayaset Red B (manufactured by Nippon Kayaku Co., Ltd., C.I. Disperse Red 60) as the sublimation dye, 60 parts of the above emulsion liquid of Joncryl ®678, 0.2 parts of Proxel ®GXL, 0.4 parts of Surfynol 104PG50, and 24 parts of ion exchange water. After 60 parts of ion exchange water and 30 parts of the emulsion liquid of Joncryl ®678 were added to the liquid obtained by the above dispersion treatment so as to have a dye content of 15%, filtration was performed using glass fiber filter paper GC-50 (manufactured by Toyo Filter Paper Co., Ltd., filter pore diameter: 0.5 μm), so that the dye dispersion liquid 2 was obtained.

The properties of the materials used in Examples and Comparative Examples are shown below.
Xylitol: viscosity of 60% aqueous solution=24.3 mPa·s
D-sorbitol: viscosity of 60% aqueous solution=32.8 mPa·s
Erythritol: viscosity of 60% aqueous solution=insoluble
propylene glycol: viscosity of 60% aqueous solution=9.8 mPa·s, surface tension of 10% aqueous solution=62.7 mN/m
1,3-propane diol: viscosity of 60% aqueous solution=8.7 mPa·s, surface tension of 10% aqueous solution=67.8 mN/m
UNIOX G-450: weight average molecular weight=450, surface tension of 10% aqueous solution=63.7 mN/m
SANNIX GP-250: weight average molecular weight=250, surface tension of 10% aqueous solution=49.6 mN/m
SC-E350: weight average molecular weight=350, surface tension of 10% aqueous solution=58.6 mN/m
SC-P750: weight average molecular weight-750, surface tension of 10% aqueous solution=46.1 mN/m
WILBRIDE S-753: weight average molecular weight=950, surface tension of 10% aqueous solution=43.3 mN/m
Triethylene glycol monomethyl ether: surface tension of 10% aqueous solution=60.6 mN/m
Diethylene glycol monombutyl ether: surface tension of 10% aqueous solution=35.0 mN/m
Triethylene glycol: surface tension of 10% aqueous solution=66.0 mN/m
1,2-butanediol: surface tension of 10% aqueous solution=53.7 mN/m
ε-caprolactam: surface tension of 10% aqueous solution=54.1 mN/m
Glycerin: viscosity of 60% aqueous solution=11.4 mPa·s
Polyglycerin #310: viscosity of 60% aqueous solution=22.8 mPa·s
Trimethyl glycine: viscosity of 60% aqueous solution=15.1 mPa·s

### 4.2. Evaluation Method

### 4.2.1. Paper Surface Drying Property

A solid pattern of the ink jet ink composition of each of Examples and Comparative Examples was printed using a PX-G930 machine (manufactured by Seiko Epson Corporation) on sublimation transfer paper EPSON DS Transfer Multi-Purpose (manufactured by Seiko Epson Corporation) so as to have an ink adhesion amount of 8±0.5 mg/inch².

Subsequently, after a predetermined time passed, a printed surface was softly wiped with a Bemcot cloth, and whether the transfer occurred or not was evaluated by visual inspection. The evaluation was performed in accordance with the following criteria, and the results thereof are shown in Table 6.
A: No transfer occurs 120 seconds after printing.
B: Transfer occurs 120 seconds after printing, and no transfer occurs 150 seconds thereafter.
C: transfer still occurs 150 seconds after printing.

### 4.2.2. Fuming Property

A solid pattern of the ink jet ink composition of each of Examples and Comparative Examples was printed using a PX-G930 machine (manufactured by Seiko Epson Corporation) on sublimation transfer paper EPSON DS Transfer Multi-Purpose (manufactured by Seiko Epson Corporation) so as to have an ink adhesion amount of 8±0.5 mg/inch2.

Subsequently, the solid pattern was transferred to 100%-polyester cloth Carl Dry (manufactured by Toray Industries, Inc.) at a temperature of 200° C. and a pressure of 465 g/cm² for 40 seconds using a desktop automatic sublimation transfer press machine AF-54TEN (manufactured by Itsumi Co., Ltd.), and a fuming amount after the transfer was evaluated by visual inspection. The evaluation was performed in accordance with the following criteria, and the results thereof are shown in Table 6.
A: no fumes are generated after transfer.
B: Although being generated after transfer, fumes disappear within five seconds.
C: Fumes are generated after transfer and are continued for five seconds or more.

### 4.2.3. Intermittent Ejection Stability

After a head voltage was adjusted so as to have a dot weight of 6±0.5 ng by a PX-G930 machine (manufactured by Seiko Epson Corporation), by using the ink jet ink composition of each of Examples and Comparative Examples, a no ink-ejection carriage movement was performed 700 passes without spitting. Subsequently, after a nozzle check pattern was printed, whether the landing deviation of ink droplets occurred or not was evaluated. The evaluation was performed in accordance with the following criteria, and the results thereof are shown in Table 6.
AA: No dot missing and no deviation occur.
A: In less than 80% of nozzles, deviation occurs.
B: In 80% or more of nozzles, deviation occurs.
C: In 50% or more of nozzles, no ejection occurs.

### 4.2.4. Clogging Recovery Property

After the ink of each Example was filled in a PX-G930 machine (manufactured by Seiko Epson Corporation), while a nozzle cap was opened, the ink was left for 5 days in a constant temperature room at a temperature of 40° C. and a humidity of 20%. Subsequently, a cleaning operation was performed three times (ink suction amounts were 4 g, 2 g, and 2 g in this order) at room temperature, and the number of non-recovered nozzles was counted. The evaluation was performed in accordance with the following criteria, and the results thereof are shown in Table 6.
A: All nozzles are recovered.
B: Number of non-recovered nozzles is 1 to 10.
C: Number of non-recovered nozzles is 11 or more.

### 4.2.5. Color Development Property

A solid pattern of the ink jet ink composition of each of Examples and Comparative Examples was printed using a PX-G930 machine (manufactured by Seiko Epson Corporation) on sublimation transfer paper EPSON DS Transfer Multi-Purpose (manufactured by Seiko Epson Corporation) so as to have an ink adhesion amount of 8±0.5 mg/inch².

Subsequently, the solid pattern was transferred to 100%-polyester cloth Carl Dry (manufactured by Toray Industries, Inc.) at a temperature of 200° C. and a pressure of 465 g/cm² for 40 seconds using a desktop automatic sublimation transfer press machine AF-54TEN (manufactured by Itsumi Co., Ltd.). Next, the OD value on the cloth was measured using a colorimeter i1PR03 (manufactured by X-rite). As the measurement conditions, D65 was used as a light source, and the density in status T was measured. The evaluation was performed in accordance with the following criteria, and the results thereof are shown in Table 6.
AA: OD value is 1.55 or more.
A: OD value is 1.50 to less than 1.55.
B: OD value is 1.45 to less than 1.50.
C: OD value is less than 1.45.

### 4.3. Evaluation Result

From Tables 2 to 6, it has been found that the ink jet ink composition of each Example has a preferable paper surface drying property and is also not likely to fume, the ink jet ink composition described above containing a sublimation dye, a sugar alcohol having at least four OH groups, a diol having two or three carbon atoms, at least one permeable moisturizer selected from the group consisting of a glycol monoether, a diol having at least four carbon atoms, an amide, and a (poly)glyceryl ether, and glycerin at a content of one percent by mass or less with respect to a total mass of the ink jet ink composition.

The present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

From the embodiments and the modified examples described above, the following conclusions are obtained.

An ink jet ink composition includes a sublimation dye, a sugar alcohol having at least four OH groups, a diol having two or three carbon atoms, at least one permeable moisturizer selected from the group consisting of a glycol monoether, a diol having at least four carbon atoms, an amide, and a (poly)glyceryl ether, and glycerin at a content of one percent by mass or less with respect to a total mass of the ink jet ink composition.

According to the ink jet ink composition described above, the sugar alcohol having at least four OH groups is not likely to be evaporated at a temperature of up to 220° C. and is also not likely to fume when being heated. In addition, according to this ink jet ink composition, since the diol having two or three carbon atoms, which has a high drying property and a low viscosity, and the permeable moisturizer are also used together, a low fuming property and a preferable paper surface drying property can both be obtained at the same time. Furthermore, according to the ink jet ink composition described above, since the content of glycerin is set to be one percent by mass or less, the fuming can be suppressed.

In the ink jet ink composition described above, the permeable moisturizer in the form of an aqueous solution at a concentration of 10 percent by mass may have a surface tension of 45 to 67 mN/m.

According to the ink jet ink composition described above, the color development property, the intermittent ejection stability, and the clogging recovery property are more excellent. Since the surface tension is more appropriate, the permeability is more appropriate, and as a result, the color development property of an image to be obtained is more preferable. Furthermore, since the viscosity and/or the evaporative thickening property is also more preferable, the clogging recovery property and/or the intermittent ejection stability is also more excellent.

In the ink jet ink composition described above, the permeable moisturizer may be present at a content of five percent by mass or less with respect to the total mass of the ink jet ink composition.

According to the ink jet ink composition described above, the clogging recovery property and the color development property are more excellent. In addition, the storage stability of the ink is also excellent.

The ink jet ink composition described above may further include at least one selected from the group consisting of a polyglycerin and a betaine.

According to the ink jet ink composition described above, the intermittent ejection stability is more excellent. Since the polyglycerin and the betaine have a low evaporative thickening property, even when a small amount thereof is added, the intermittent ejection stability is improved.

In the ink jet ink composition described above, the diol having two or three carbon atoms may be present at a content of 5 to 15 percent by mass with respect to the total mass of the ink jet ink composition.

According to the ink jet ink composition described above, the fuming can be further suppressed, and the paper surface drying property and the intermittent ejection stability are also more excellent.

In the ink jet ink composition described above, the sugar alcohol in the form of an aqueous solution at a concentration of 60 percent by mass may have a viscosity of 35 mPa·s or less.

According to the ink jet ink composition described above, the influence of the evaporative thickening property of the sugar alcohol is more likely to be reduced, and the intermittent ejection stability is more excellent.

In the ink jet ink composition described above, the sugar alcohol may be present at a content of 3 to 15 percent by mass with respect to the total mass of the ink jet ink composition.

According to the ink jet ink composition described above, in addition to the advantages described above, the clogging recovery property, the color development property, and the intermittent ejection stability can be more preferably obtained at the same time.

In the ink jet ink composition described above, the permeable moisturizer may include a (poly)glyceryl ether.

According to the ink jet ink composition described above, the fuming is further suppressed, and the advantages described above can be more significantly obtained.

In the ink jet ink composition described above, the (poly)glyceryl ether may have a weight average molecular weight of 300 to 800.

According to the ink jet ink composition described above, the fuming can be further suppressed, and the color development property of the image is more excellent.

An ink jet recording method includes a recording step of adhering one of the ink jet ink compositions described above to a surface of a sheet-shaped recording medium, a transfer step in which after the sheet-shaped recording medium is disposed so that a recorded surface thereof overlaps a dyeing object, the sublimation dye is sublimation-transferred to the dyeing object by heating at a temperature of 150° C. to 220° C., and after the transfer step is performed, a peeling step of peeling the sheet-shaped recording medium away from the dyeing object.

According to the ink jet recording method described above, since the sublimation transfer temperature is 150° C. to 220° C., the sugar alcohol is suppressed from being evaporated, and the generation of fumes can be suppressed.

An ink jet recording method includes a recording step of adhering one of the ink jet ink compositions described above to a sheet-shaped recording medium, a drying step of heating the sheet-shaped recording medium to which the ink jet ink composition is adhered to a temperature of 50° C. or more, and after the drying step is performed, a recovery step of winding the sheet-shaped recording medium in the form of a roll.

According to the ink jet recording method described above, since the diol is evaporated by the drying step in which the temperature is increased to 50° C. or more, the paper surface drying property is preferable, and the fuming in the transfer can also be suppressed. In addition, since the ink jet ink composition described above is used, the paper surface drying property is also preferable, and the bleed-through is not likely to occur.

An ink jet recording apparatus includes an ink jet head to adhere one of the ink jet ink compositions described above to a sheet-shaped recording medium, a heater to heat the sheet-shaped recording medium to a temperature of 50° C. or more, and a roller to wind the sheet-shaped recording medium in the form of a roll.

According to the ink jet recording apparatus described above, since the ink jet ink composition described above is used, the paper surface drying property on the recoding medium is preferable, and even when the recording medium is wound around a roller, the bleed-through is not likely to occur.

What is claimed is:

1. An ink jet ink composition comprising:
a sublimation dye;
a sugar alcohol having at least four OH groups;
a diol having two or three carbon atoms;
at least one permeable moisturizer selected from the group consisting of a glycol monoether, a diol having at least four carbon atoms, an amide, and a (poly)glyceryl ether; and
glycerin at a content of zero percent by mass or more and one percent by mass or less with respect to a total mass of the ink jet ink composition.

2. The ink jet ink composition according to claim 1,
wherein the permeable moisturizer in the form of an aqueous solution at a concentration of 10 percent by mass has a surface tension of 45 to 67 mN/m.

3. The ink jet ink composition according to claim 1,
wherein the permeable moisturizer is present at a content of zero percent by mass or more and five percent by mass or less with respect to the total mass of the ink jet ink composition.

4. The ink jet ink composition according to claim 1, further comprising:
at least one selected from the group consisting of a polyglycerin and a betaine.

5. The ink jet ink composition according to claim 1,
wherein the diol having two or three carbon atoms is present at a content of 5 to 15 percent by mass with respect to the total mass of the ink jet ink composition.

6. The ink jet ink composition according to claim 1,
wherein the sugar alcohol in the form of an aqueous solution at a concentration of 60 percent by mass has a viscosity of 35 mPa·s or less.

7. The ink jet ink composition according to claim 1,
wherein the sugar alcohol is present at a content of 3 to 15 percent by mass with respect to the total mass of the ink jet ink composition.

8. The ink jet ink composition according to claim 1,
wherein the permeable moisturizer includes a (poly)glyceryl ether.

9. The ink jet ink composition according to claim 8,
wherein the (poly)glyceryl ether has a weight average molecular weight of 300 to 800.

10. An ink jet recording method comprising:
a recording step of adhering the ink jet ink composition according to claim 1 to a surface of a sheet-shaped recording medium;
a transfer step in which after the sheet-shaped recording medium is disposed so that a recorded surface thereof overlaps a dyeing object, the sublimation dye is sublimation-transferred to the dyeing object by heating at a temperature of 150° C. to 220° C.; and
after the transfer step is performed, a peeling step of peeling the sheet-shaped recording medium away from the dyeing object.

11. An ink jet recording method comprising:
a recording step of adhering the ink jet ink composition according to claim 1 to a sheet-shaped recording medium;
a drying step of heating the sheet-shaped recording medium to which the ink jet ink composition is adhered to a temperature of 50° C. or more; and
after the drying step is performed, a recovery step of winding the sheet-shaped recording medium in the form of a roll.

12. An ink jet recording apparatus comprising:
an ink jet head to adhere the ink jet ink composition according to claim 1 to a sheet-shaped recording medium;
a heater to heat the sheet-shaped recording medium to a temperature of 50° C. or more; and
a roller to wind the sheet-shaped recording medium in the form of a roll.
